(19) United States
(12) Patent Application Publication
(10) Pub. No.: US 2005/0031147 A1
(43) Pub. Date: Feb. 10, 2005

(54) Underwater entertainment system

(76) Inventor: Roar Viala, Oceanside, CA (US)

Correspondence Address: James A. Gavney Jr., 725 Wildwood Lane, Palo Alto, CA, 94303, US

(21) Appl. No.: 10/803,390

(22) Filed: Mar. 18, 2004

Related U.S. Application Data
(60) Provisional application No. 60/493,667, filed on Aug. 7, 2003.

(51) Int. Cl. H04R 1/10; H04R 1/02; H04R 25/00

(52) U.S. Cl. 381/334; 381/74; 381/376

(57) ABSTRACT

An entertainment system for use in a water environment is disclosed. The system preferably comprises an MP3 player unit that is housed in a water resistant housing and water resistant speaker units with sealed membrane transducers configured to be placed on and secured to bony portions of a user's head to transmit sound therefrom. The entertainment system also preferably comprises an input means, such as a USB port, for transmitting MP3 files to a memory unit from one or more media data sources, such as a network, a computer or a hard drive.

### RELATED APPLICATIONS

This application claims priority under 35 U.S.C. § 119(e) from the co-pending U.S. provisional patent application Ser. No. 60/493,667, filed on Sep.7, 2003, and titled “UNDERWATER DIGITAL MUSIC PLAYER.” The provisional patent application Ser. No. 60/493,667, filed on Sep. 7, 2003, and titled “UNDERWATER DIGITAL MUSIC PLAYER” is hereby incorporated by reference.

### FIELD OF THE INVENTION

This invention relates to entertainment systems. More particularly, this invention relates to an entertainment system for use in a water environment or while submersed in water.

### BACKGROUND

There are a number of small, media players available. For example, there are CD players, MP3 players and radios that can be carried around while preforming a number of independent tasks. Such entertainment systems have been made smaller by the advances in processor and memory technologies. These small, light weight and portable entertainment systems can be configured to operate with a number of different audio output units, such as headphones or earpieces. However, these prior art devices are not suitable for operation all environments.

Accordingly, there is a need for a small, lightweight and portable entertainment system that is capable of operating in a variety of environmental conditions. Preferably, the entertainment system can be used to play digital media files, such as MP3 files, while in a water environment or while submersed in water.

### BRIEF DESCRIPTION OF FIGURES

FIG. 1 shows an entertainment system, in accordance with the embodiments of the invention.

FIG. 2 shows an entertainment system configured to secure to a user's head, in accordance with the embodiments of the invention.

FIG. 3A shows a touch control architecture for inputting system functions into an entertainment system, in accordance with the embodiments of the invention.

FIG. 3B shows an entertainment system configured to couple to a strap for securing the entertainment system to a portion of a user's body, in accordance with the embodiments of the invention.

FIG. 4A-B show exploded views of an underwater entertainment system, in accordance with the embodiments of the invention.

FIG. 5 shows a speaker-earplug for transmitting audio output signals from an entertainment system to a user's ear, while the user is in a water environment or submersed in water, in accordance with the embodiments of the invention.

FIG. 6 shows a sealed membrane speaker unit for transmitting audio output signals through a bony portion of a user's head, in accordance with the embodiments of the invention.

FIG. 7 shows a swimmer with a head band entertainment system comprising a MP3 player and built-in speaker units, in accordance with the embodiments of the invention.

### SUMMARY OF THE INVENTION

The present invention is directed to an entertainment system. In accordance with the embodiments of the invention, the system is configured to play media in a water environment and/or under water. It is understood that here and throughout the text of this application the term “water resistant” means that water does not readily flow into direct contact with electronic portions of the entertainment system while the entertainment system is underwater. It is also understood that the term water resistant encompasses the term “water proof” and that the entertainment system of the present invention can be made to withstand water environments such as those encountered while scuba diving, snorkeling and the like.

An entertainment system, in accordance with the embodiments of the invention, comprises a media player unit that is housed in a water resistant housing and is configured for processing media data to generate audio output signals therefrom. The system also preferably comprises an input means for inputting the media data into the media player unit and an output means for outputting the generated audio signals as sound, which can be heard by a user while in the water environment and/or under water. It is understood hence forth that the term “play” means to access media data, process the media data and generate audio output signals therefrom, which can be transformed into sound using suitable output means, such as described below. Also, it is understood that an entertainment system of the present invention can be powered by a disposable or rechargeable battery unit that is built into the entertainment system or that is removable from the entertainment system. In the case of a rechargeable battery unit, the battery unit can be configured to recharge by any external power source, such as a wall outlet charger or a built-in power source, such as a solar cell or a motion generator.

The input means, in accordance with the embodiments of the invention, comprises an input port for transmitting media data to a media player unit from a media data source, such as a network, a computer, a hard drive or any other suitable media source. For example in one embodiment, the input means comprises a USB connection coupled to the media player unit, wherein a USB cable can be connected to a USB port of a computer, a hard drive, the Internet or any other media data source to stream or otherwise transfer media data to a built-in memory unit of the media player unit. The input means can also include a removable memory port and a removable memory unit that is accessed by the media player unit to play media data stored thereon. For example, in one embodiment the input means includes a memory port and a flash card, a secured digital memory card, a memory stick or any other removable memory unit known in the art. In accordance with further embodiments of the invention, the input means can include a receiver unit for receiving wireless transmission of media data at the media player unit. The media player unit can also be configured to receive and play a “live stream” of media data received by the wireless transmissions or can be configured to store the media data received by the wireless transmissions on to a built-in or removable memory unit and play the stored media data at a later time.

The output means for outputting audio signals, such as described above, preferably comprises one or more water resistant speaker units that are configured to be placed on a bony portion of a user's head and transmit sound therefrom. For example, a water resistant speaker unit can comprises a sealed membrane transducer that is configured to be placed and secured against the user's forehead, a side of the user's head or any other bony portion of the user's head. In accordance with this embodiment, the entertainment system includes a means for plugging the user's ears, such as a set of ear plugs. The ear plugs can be separate from the water resistant speaker units or can be coupled to the water resistant speaker units through a support structure, such that water resistant speaker units and the ear plugs are simultaneously secured to the user's head. Regardless of the configuration chosen, the ear plugs help to reduce background noise and keep water out of the user's ears while the user is in a water environment or under water. In accordance with an alternative embodiment of the invention, the output means comprises one or more water resistant speaker units that are configured to be seated within cavities of the user's ear canals. In accordance with this embodiment, the water resistant speaker units serve to produce and transmit sound as well plug the user's ears while the user is in a water environment or under water.

In accordance with the embodiments of the invention, an entertainment system comprises a media player, such as described above, that is a digital media player unit. The digital media player unit comprises a media storage unit for receiving and storing digital media data (recording digital media data), a digital processor unit for playing digital media data (a digital signal processor (DSP)) and related circuitry, such as a digital-to-analog converter, data storage circuitry, software, an amplifier, etc. The processor unit can be configured with applications software that allows a user to create a custom play list and navigate through the play list to select files (e.g., music files) to be played. The processor unit can also be configured with firmware that allows a user to program the entertainment system, such as described below.

In a preferred embodiment of the invention, the system is an MP3 player that is configured to play media data files in MPEG-1 Audio Layer-3 compressed format (MP3 format). The MP3 player unit is preferably configured to couple to a user's head through a strap, a clip or any other suitable means, but can be configured to couple to any portion of a user's body. The MP3 player unit comprises a water resistant housing for housing a media storage unit that stores MP3 files and a processor unit that decompresses and plays the MP3 files. The water resistant housing preferably comprises touch controls for operating the MP3 player unit. The touch controls can be configured to initiate any number of system functions such as play selected files, skip files, change an output volume of the system, and input program commands into the system, to name a few. The water resistant housing can also include an indicator for indicating an operational status of the MP3 player. The indicator can include a light, such as an LED, an audible indicator, such as an alarm, and/or a display, such as a LCD. The system can also include water resistant speaker units, such as described above, that are configured to detachably couple to the MP3 player unit through connectors on the water resistant housing or the water resistant speaker units can be integrally formed with the water resistant housing. As described above, the water resistant speaker units are preferably configured to transmit sound by contacting and securing to bony portions of a user's head and are preferably used with a set of ear plugs to reduce background noise and keep water out of the user's ears while the user is in a water environment or under water.

### DETAILED DESCRIPTION OF THE INVENTION

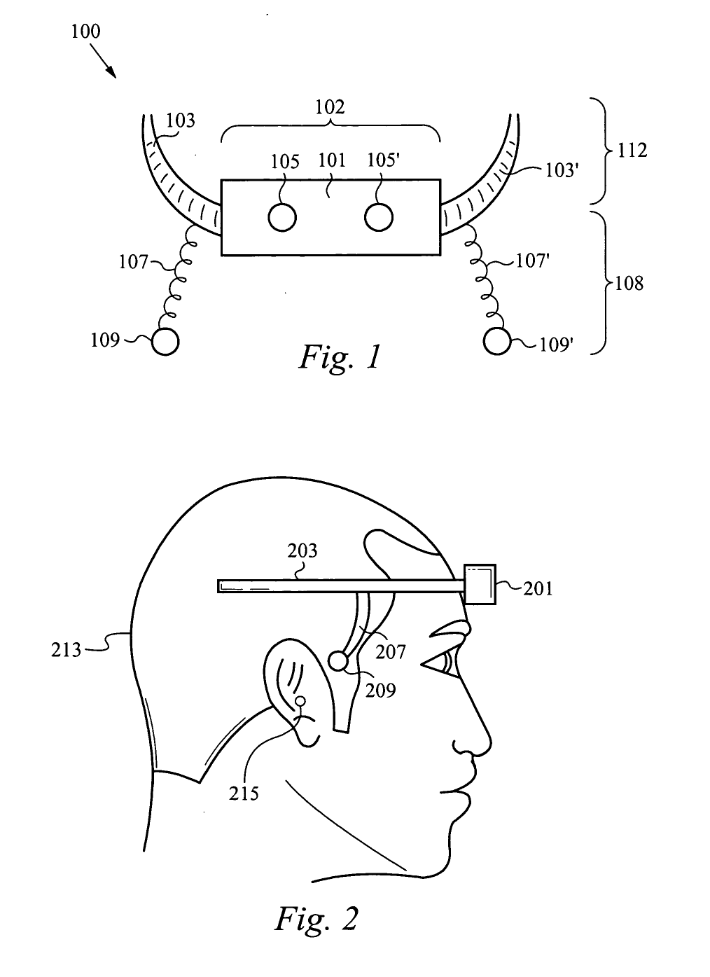

Referring to FIG. 1, the present invention is directed to an entertainment system 100 comprising a media player unit 102 that is housed in a water resistant housing 101. Preferably, the media player unit 102 is an MP3 player with a water resistant housing 101. The MP3 player includes a media storage unit 111 for receiving and storing the digital media data (recording digital media data), a digital processor unit 1 13 for playing the digital media data (a digital signal processor (DSP), and related circuitry, such as a digital-to-analog converter, data storage circuitry, software, an amplifier and etc. The processor unit 113 can be configured with applications software that allows a user to create custom play lists and to navigate through the play list to select files to be played.

Still referring to FIG. 1, the entertainment system 100 also preferably comprises a input means 105 which can include a port or slot for inserting a removable memory unit, such as a flash card, a secured digital memory card, a memory stick or any other removable memory unit known in the art. Preferably, the input means 105 includes an input port for transmitting media data to the media player unit 102 from a media data source, such as a network, a computer, a hard drive or any other suitable media source 120. For example, the input means 105 can comprises a USB connection for connecting to a USB cable that can be connected to a computer, a hard drive, the Internet or any other media data source 120 to download or stream media data to the built-in media storage unit 111 of the media player unit 102.

In accordance with further embodiments of the invention, an input means comprises a receiver unit 115 contained within the water resistant housing 101 for receiving wireless transmissions of media data that can be stored on a removable memory unit and/or a built-in media storage unit 111, as described above. In accordance with yet further embodiments of the invention, receiver unit 115 comprises a radio for receiving wireless media data and playing the media data in real time through a suitable output means, such as described in detail below.

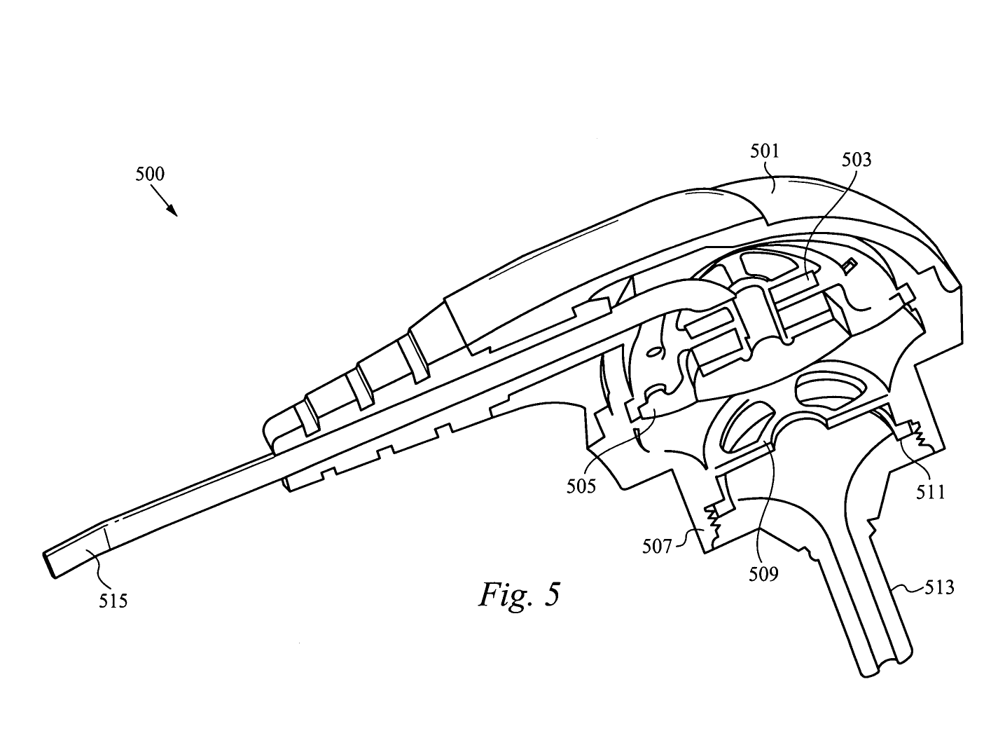

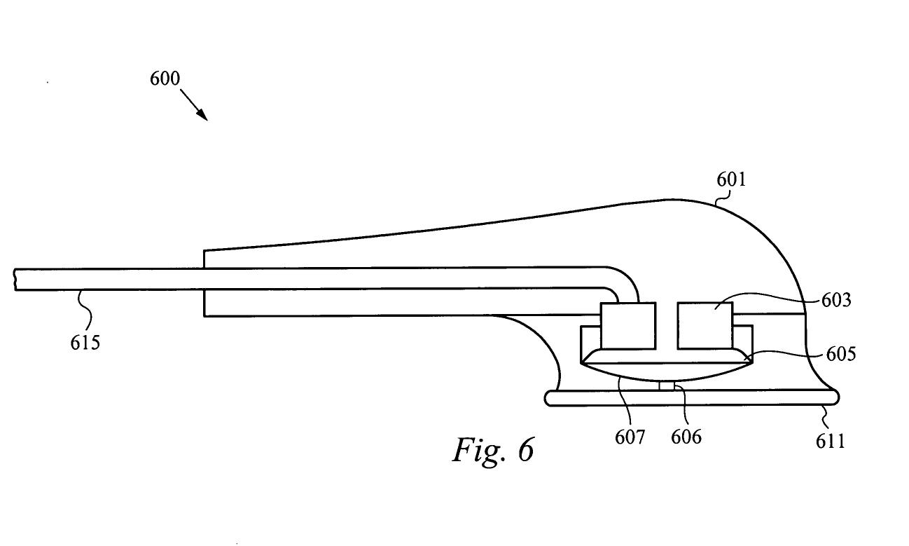

Still referring to FIG. 1, an entertainment system 100 in accordance with the embodiments of the invention comprises an output means 108 for providing a representation of audio signals generated by the media player unit 102. The output means can include a pair of water resistant speaker units 109 and 109′ that are coupled to the media player unit 102 through water resistant wire connections 107 and 107′, respectively. The pair of water resistant speaker units 109 and 109′ can be configured to be inserted into a user's ears or secured against bony portions of the user's head or other body part while the user is in a water environment or submersed under water, such as described in detail with reference to FIG. 5 and FIG. 6, respectively. The entertainment system 100 also preferably comprises an attachment means 112 for attaching the media player unit 102 to a portion of a user's body. For example, the entertainment system 100 comprises a pair of straps, clasps or support structures 103 and 103′ for securing the media player unit 102 to an arm, a waist or a head of the user. Preferably, the entertainment system 100 comprises an attachment means 102 that is configured to secure the media player unit 102 to the user's head. However, it will be clear to one skilled in the art that the media player unit 102 can be secured to any portion of a user's body or auxiliary equipment, such as goggles, sunglasses, belts, backpacks and the like, using any number of attachment means including, but not limited to, clips, screws and hook and loop fabric to name a few.

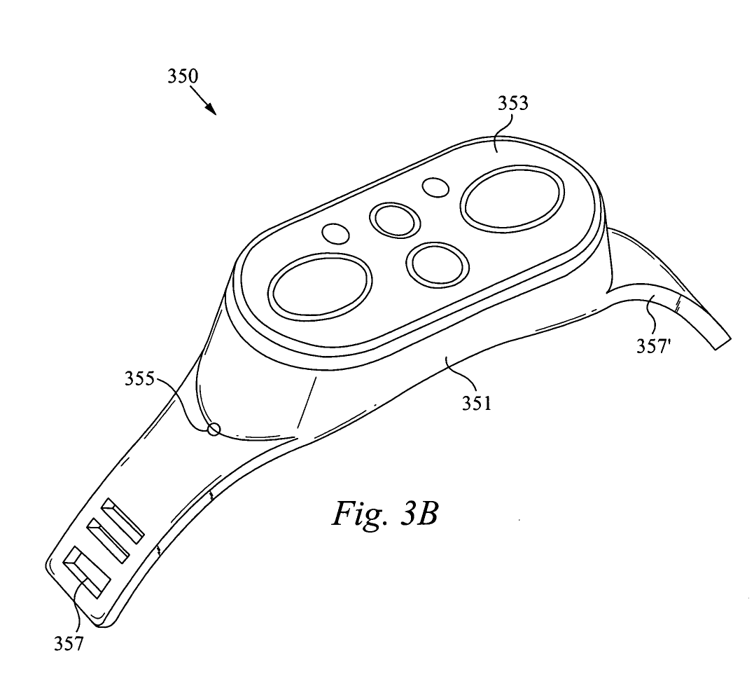

The media player unit 102 is also preferably configured with one or more control buttons 125 for inputting operational commands and/or programming the entertainment system 100, such as described below with reference to FIG. 3. The entertainment system 100 of the present invention is preferably powered by a battery unit 117 that is a disposable or is rechargeable and built in to the housing 101.

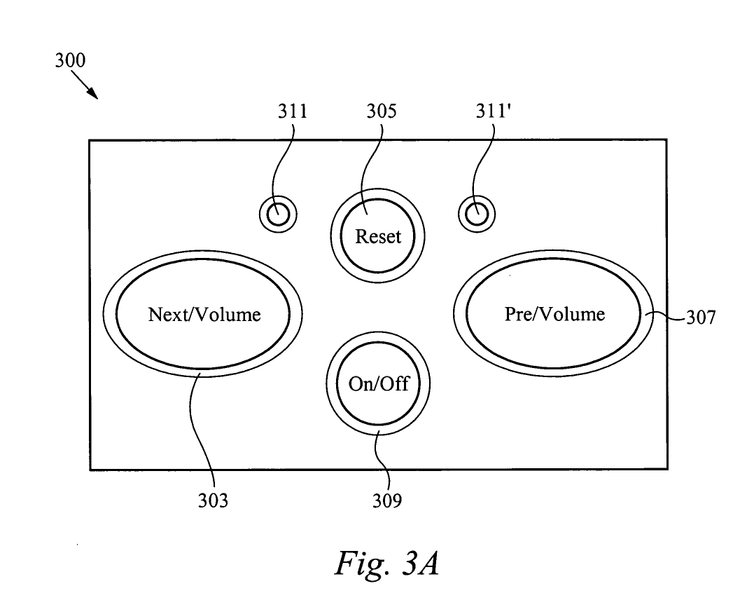

Referring now to FIG. 2, an entertainment system in accordance with the embodiments of the invention comprises a water resistant media player unit 201 configured to play MP3 files that are stored on a suitable memory unit and an attachment means 203 for securing the media player unit 201 to a user's head 213. The entertainment system also comprises one or more water resistant speaker units 209 that are configured to transmit an audio output to a bony portions of the user's head 213. The one or more water resistant speaker units 209 can be coupled to the attachment means 203 or any other portion of the entertainment system through a support structure 207 to help support and secure the one or more water resistant speaker units 209 against the bony portions of a user's head 213.

In operation, the entertainment system is attached to the user's head with the one or more water resistant speaker units 209 secured against bony portions of the user's head 213. To improve the quality of the audio output from the one or more water resistant speaker units 209, it is preferable that the user also plugs his or her ears with ear plugs 215 to keep water out of the canals of the ears and allow sound to be transmitted to the inner portions of the ears. It will be clear to one skilled in the art from the following description that the one or more water resistant speaker units 209 can be secured to or held against bony portions of the user's head by any number of different methods, including tucking the water resistant speaker units 209 under a swimming cap or a swimming goggle strap.

FIG. 3 show an example of a control button and/or display architecture 300, in accordance with the embodiments of the invention. The control button and/or display architecture 300 can comprise a number of sealed touch controls 303, 305, 307 and 309 which allow a user to input such operational commands as changing an output volume, selecting a media file to be played, turning the media player on and off, resetting the media player, tuning a radio receiver, to name a few. The touch control buttons 303, 305, 307 and 309 can be used in conjunction with firmware that allows an entertainment system to be programmed in any number of different ways, such as to player a preferred play list, to turn on or turn off at a selected time, to name a few. The control buttons 303, 305, 307 and 309 and/or display architecture 300 can also include one or more display lights 311 and 311′ that provide an indication of the operational state of the entertainment system. For example, the display lights 311 and 311′ can indicate when the entertainment system is on, when the entertainment system is playing a media file and the like. The display lights 311 and 311′ are preferably LED display lights.

An entertainment system, in accordance with further embodiments of the invention can have any number of different control buttons and/or display features that include LED arrays and/or LCDs. The entertainment system of the present invention can also include an audible indicator, such as an alarm that signals a time or status of the entertainment system.

FIG. 3B shows an entertainment system 350 configured to couple to a portion of a user's body, in accordance with the embodiments of the invention. The entertainment system 350 comprises an MP3 player that is housed within a water resistant housing 351, as described above. Preferably, the water resistant housing 351 includes a touch control panel 353 with touch control buttons for inputting control commands to operate the MP3 player, such as described with reference to FIG. 3A. The entertainment system 350 can also include one or more attachment features 357 and 357′ coupled to the water resistant housing 351. The attachment features 357 and 357′ can be configured to attach to a strap (not shown), which can then be used to secure the entertainment system 350 to a portion of a user's body.

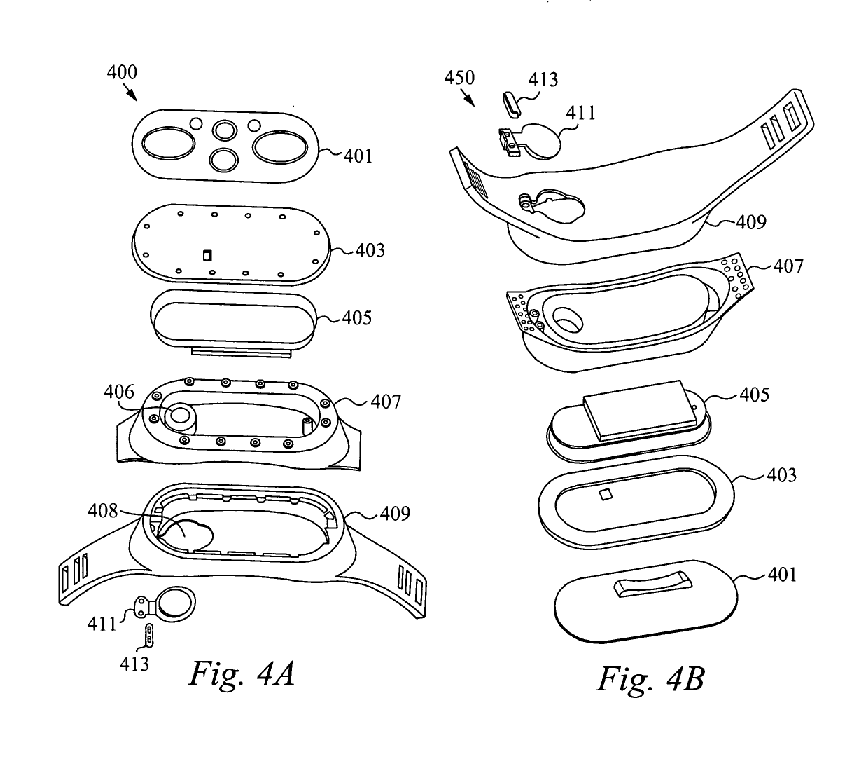

Still referring to FIG. 3B, the water resistant housing 351 and the attachment features 357 and 357′ are preferably formed from molded plastic or rubber. The entertainment system 350 has at least one output connection 355 for connecting to one or more output units, such s described above. Also the entertainment system 350 is preferably configured with an input port for connecting to a data source, as described below with reference to FIGS. 4A-B.

FIGS. 4A-B show exploded views 400 and 450 of an underwater entertainment system, in accordance with the embodiments of the invention. FIG. 4A shows a top exploded view 400 and FIG. 4B shows a bottom exploded view 450, respectfully. The underwater entertainment system can be formed from a top control pad 401 with touch controls for imputing control commands, as described above with reference to FIGS. 3A-B. Next, the underwater entertainment system can include an upper casing 403 that fits to a lower casing 407 to.form a housing structure for housing an electronic unit 405. The electronic unit 405 preferably includes all of the necessary circuitry, memory, amplifiers and power source required for downloading, storing and playing MP3 files, such as described above. Next the entertainment system has a strap casing 409 that fits to the housing structure formed from the upper casing 403 and the lower casing 407 and preferably provides a means for securing the underwater entertainment system to a portion of a user's body.

Still referring to FIGS. 4A-B, the lower casing 407 and the strap casing 409 can have apertures 406 and 408, respectfully, that form an input port for inputting data files to the electric unit 405. The input port can be covered with a cap structure 411 that is secured to the strap casing 409 through a rivet member 413. All of the components 401, 403, 405, 407, 409, 411 and 413 that combine to form the entertainment system, can be secured, fitted or interlocked together using any number of securing mechanisms including, but not limited to, rubber rivets, glue and the like. Furthermore, the entertainment system of the present invention can include any number of gaskets or seals required to provide durability and water resistance required for the intended use.

FIG. 5 shows a water resistant ear plug/speaker unit 500 that can be used for outputting a representation of audio signals generated by a media player unit, such as described above. The water resistant ear plug/speaker unit 500 comprises a housing 501 for housing electronic components of the ear plug/speaker unit 500. The ear plug/speaker unit 500 preferably comprises a nozzle or cone structure 513 for inserting into a user's's ear and delivering sound to the user's ear therefrom. An outer portion 507 of the nozzle or cone structure 513 can be formed from a soft malleable material that allows the ear plug/speaker unit 500 to adapt to different ear shapes. Within the housing 501, there is a fenestrated member 509 that allows water to drain from a cavity between the fenestrated member 509 and a transducer 503. Preferably, the transducer 503 has a sealed membrane structure 505 that oscillates to generate sound from audio signals received by a media player unit through a water resistant electrical connection 515.

FIG. 6 shows a water resistant speaker unit 600 for providing a representation of audio signals generated by a media player unit, in accordance with a preferred embodiment of the invention. The water resistant speaker unit 600 comprises a housing 601 for housing electronic components of the water resistant speaker unit 600. The water resistant speaker unit 600 preferably comprises a transducer 603 with an oscillating diaphragm 607 for generating sound from audio signals received by a media player unit through a water resistant electrical connection 615. The water resistant speaker unit 600 also includes a sealed membrane 611 that is configured to be placed on and secured to a bony portion of the user's head and transfer sound therefrom to the inner portion of the user's ears. The water resistant speaker unit 600 can include a transmitting or coupling structure 606 that is configured to facilitate mechanical transmission of audio signals from the oscillating diaphragm 607 to the sealed membrane 611. Alternatively, ths oscillating diaphragm 607 can be sealed and placed in direct contact with a bony portion of the user's head to transit sound therefrom. As stated above, the water resistant speaker unit 600 can be secured to bony portions of a user's head using any number of means including, but not limited to, brackets, clips and straps that are either part of the entertainment system or that are separate from the entertainment system.

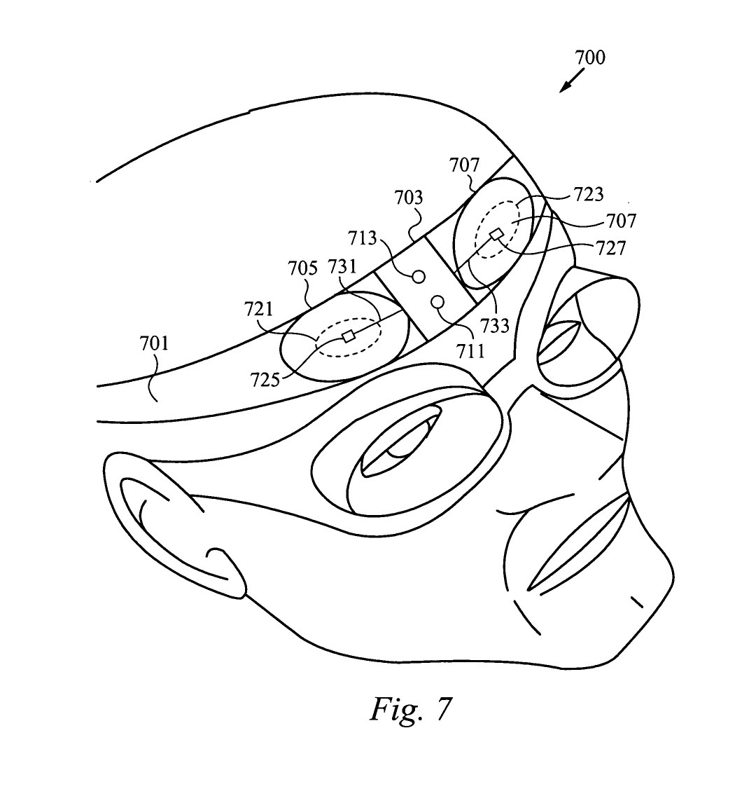

FIG. 7 illustrates an entertainment system 702 that is configured to attach to a user's head 700, in accordance with further embodiments of the invention. The entertainment system 702 is configured to wrap around a forehead portion of the user's head 700 through a flexible strap 701. The entertainment system 702 comprises a media player unit 703 with all of the necessary components to receive, store and play media data files, including a processor, a memory unit, a power source and an amplifier circuit, such as described in detail above. Also, the entertainment system 702 is preferably configured with controls and/or displays 711 and/or an input port 713, also described above. In accordance with this embodiment, the entertainment system 702 comprises water resistant speakers 705 and 707 that are built into the strap 701 and housed in water resistant housing structures on the strap 701. The water resistant speakers 705 and 707 comprise transducers 725 and 727 with sealed membranes 721 and 723 that are configured to be placed in contact with the user's forehead and held against the user's forehead through the strap 701. The transducers 725 and 727 are coupled to the media player unit 703 through sealed electrical connections 731 and 733 to receive audio signals generated from the media player unit 703 and convert the audio signals to sound waves that are then transmitted to the user through the user's forehead.

There are a number of small media players available but none are suitable for operation in a water environment, such as with the present invention. Water should remain substantially out of the ear canals of the user in order to deliver suitable sound quality to the user. The present invention achieves this goal by transmitting sound to inner portions of the user's ears through bony portions of the user's's head or through the user's ear canals while the user's ears are plugged.

The present invention has been described in terms of specific embodiments incorporating details to facilitate the understanding of the principles of construction and operation of the invention. As such, references, herein, to specific embodiments and details thereof are not intended to limit the scope of the claims appended hereto. It will be apparent to those skilled in the art that modifications can be made in the embodiment chosen for illustration without departing from the scope of the invention.

1. A system for underwater entertainment, the system comprising:
a) media player unit for playing media data and generating audio signals therefrom;
b) an input means for inputting the media data into the media player unit;
c) a water resistant housing for housing the media player unit; and
d) an output means for outputting the audio signals.

2. The system of claim 1, further comprising means for coupling the media player unit to a user's head.

3. The system of claim 1, wherein the output means comprises a water resistant speaker for conducting the audio signals to a portion of a user's head.

4. The system of claim 3, wherein the water resistant speaker comprises a detachable connector feature for detachably coupling to an output port on the water resistant housing.

5. The system of claim 3, wherein the water resistant speaker comprises a sealed diaphragm for contacting a bony portion of a user's head.

6. The system of claim 1, further comprising means for plugging the user's ears while the sealed diaphragm is in contact with the bony portion of the user's head.

7. The system, of claim 1, wherein the media player is an MP3 player configured to play MPEG-1 Audio Layer-3 compressed format media files.

8. The system of claim 1, wherein the input means comprises a memory device for storing the media data.

9. The system of claim 8, wherein the memory device comprises a removable memory unit.

10. The system of claim 1, wherein the input means comprises an input port for transmitting the media data to the media player unit from a media data source.

11. The system of claim 10, wherein the input port comprises a USB connection for coupling to the media data source through a computer.

12. The system of claim 1, wherein the water resistant housing comprises controls for operating the media player unit.

13. A system for playing digital media data, the system comprising an underwater media player comprising:
a) a media storage unit for storing the digital media data;
b) a digital processor for reading and converting the digital media data into audio output signals; and
c) means for transmitting the audio output signals to a water resistant audio output unit, wherein a user can listen to the audio output signals while submersed in water and with the water resistant audio output unit coupled to a portion of the user's head.

14. The system of claim 13, further comprising a water resistant housing for housing the media storage unit and the digital processor, the water resistant housing being configured for coupling to the user's head.

15. The system of claim 13, further comprising means for transmitting the digital media data to the media storage unit from a media data source.

16. The system of claim 15, wherein the means for transmitting the digital media data to the media storage unit from the media data source comprises one or more of a physical connection and a wireless receiver.

17. The system of claim 13, wherein the digital processor is configured to decompress the media data stored on the media storage unit in a compressed format.

18. The system of claim 17, wherein the compressed format is an MP3 format.

19. The system of claim 13, wherein the water resistant audio output unit comprise a sealed membrane transducer that is configured to couple to the portion of the user's head.

20. The system of claim 19, further comprising ear plugs.

21. A system for playing music while in a water environment, the system comprising:
a) an MP3 player and recorder contained within a water resistant housing for playing and recording MP3 files;
b) one or more water resistant sealed membrane transducers coupled to the MP3 player and recorder for producing audible representations of the MP3 files with the one or more water resistant sealed membrane transducers in contact with a bony portion of a user's head; and
c) an input port for down-loading MP3 files from a computer.

22. The system of claim 21, further comprising means for coupling the MP3 player and recorder to a portion of the user's body.

23. The system of claim 22, wherein the means for coupling the MP3 player to the portion of the user's body comprises one or more of a strap and a clip.
